(19) United States
(12) Patent Application Publication
(10) Pub. No.: US 2025/0030374 A1
(43) Pub. Date: Jan. 23, 2025

(54) MOTORIZED CRUSHING APPARATUS

(71) Applicant: LEEDARSON LIGHTING CO.,LTD., Zhangzhou (CN)

(72) Inventors: Wenchang Huang, Zhangzhou (CN); Tao Wang, Zhangzhou (CN); Jinzong Tang, Zhangzhou (CN); Jintian Lin, Zhangzhou (CN); Huaming Li, Zhangzhou (CN); Wenrong Chen, Zhangzhou (CN)

(21) Appl. No.: 18/776,971

(22) Filed: Jul. 18, 2024

(30) Foreign Application Priority Data
Jul. 21, 2023 (CN) 202321940352.6

(51) Int. Cl. H02P 31/00; B02C 25/00

(52) U.S. Cl. CPC H02P 31/00; B02C 25/00

(57) ABSTRACT

A motorized crushing apparatus includes a zero voltage detector, a manual switch, a motor driver, a motor and a controller. The zero voltage detector is coupled to an AC power source. When a varying voltage of the AC power source is below zero, the zero voltage detector generates a first signal. When the varying voltage of the AC power source is above zero, the zero voltage detector generates a non-zero signal. The manual switch is provided for a user to select a crushing pattern from multiple candidate crushing patterns. The controller is coupled to the zero voltage detector, the manual switch and the motor driver. The controller generates a control signal corresponding to the selected crushing pattern to alternatively turn on and turn off the motor driver under a schedule pattern.

### FIELD

The present invention is related to a motorized crushing apparatus, and more particularly related to a motorized crushing apparatus with a flexible control.

### BACKGROUND

Food blenders have become an essential appliance in many households, transforming the way people prepare their food and enhancing their daily lives. These versatile machines are used for a variety of culinary tasks, from making smoothies and soups to grinding spices and pureeing vegetables. The convenience and efficiency provided by food blenders save time and effort in the kitchen, allowing individuals to create healthy and delicious meals with ease.

At the core of a food blender's functionality are the blades housed within its container, driven by a powerful motor. This motorized operation enables the blades to rotate at high speeds, effectively breaking down ingredients into smooth and consistent textures. The simplicity of this design-blades, a container, and a motor-makes the food blender an accessible and user-friendly appliance for people of all ages and cooking skills.

Despite the widespread use and popularity of food blenders, the options available to consumers are often limited. Most blenders offer only a handful of preset functions, such as blending, pulsing, and crushing. While these presets can be convenient, they do not always meet the diverse needs of users who may require more specialized functions for their culinary creations. This limitation can restrict the potential of what can be achieved with a food blender.

The limited options available in current food blenders highlight the need for more innovative solutions. Users are seeking appliances that offer greater versatility and customization to suit their specific preferences and dietary requirements. However, the challenge lies in providing this added functionality without complicating the user experience. A blender that is too complex can deter users and negate the convenience that it is supposed to offer.

An overly complicated interface on a food blender can indeed make users' lives harder. If the controls are not intuitive or require a steep learning curve, users may become frustrated and less likely to use the appliance to its full potential. The goal should be to balance advanced features with simplicity, ensuring that even the most technologically enhanced blender remains easy to operate.

One approach to this balance is to integrate smart technology that can adapt to the user's habits and preferences over time. Such technology could offer recommendations or automate certain functions based on previous usage patterns. This way, the blender remains user-friendly while still offering a broad range of capabilities. It is important to design these features in a way that enhances, rather than complicates, the user experience.

The physical design of the blender should also be considered when adding new features. A compact and ergonomic design can make the appliance more appealing and easier to handle. Additionally, ensuring that the blender is easy to clean and maintain is crucial, as this directly impacts its usability and convenience. Users should not feel overwhelmed by the upkeep of their appliance.

Furthermore, the durability and reliability of the blender are key factors that influence user satisfaction. A well-designed blender should be able to handle a variety of tasks without frequent breakdowns or the need for constant repairs. High-quality materials and robust construction can help achieve this, providing users with a dependable appliance that lasts for years.

Finally, it is important to recognize that while food blenders are versatile, some tasks require specialized equipment. Ice crushing, for instance, is typically handled by dedicated ice crushers due to the unique characteristics of ice. Crushing ice requires specific blade designs and motor power that may not be present in standard food blenders. Recognizing these limitations can help in designing more effective kitchen appliances.

In conclusion, while food blenders have significantly enhanced the way people prepare food, there is room for improvement in their design and functionality. By addressing the limitations and ensuring that any added complexity does not compromise usability, we can create more versatile and user-friendly appliances. Special considerations, such as the specific requirements for ice crushing, should also be taken into account to provide the best possible experience for users.

### SUMMARY

In some embodiments, a motorized crushing apparatus includes a zero voltage detector, a manual switch, a motor driver, a motor and a controller.

The zero voltage detector is coupled to an AC power source.

When a varying voltage of the AC power source is below zero, the zero voltage detector generates a first signal.

When the varying voltage of the AC power source is above zero, the zero voltage detector generates a non-zero signal.

The manual switch is provided for a user to select a crushing pattern from multiple candidate crushing patterns.

The motor driver is coupled to the AC power source.

The motor is coupled to the motor driver to carrying a crushing device to crush an object in a container.

The controller is coupled to the zero voltage detector, the manual switch and the motor driver.

The controller generates a control signal corresponding to the selected crushing pattern to alternatively turn on and turn off the motor driver under a schedule pattern.

Different candidate crushing patterns correspond to different control signals of different schedule patterns for crushing the object into different sizes and shapes.

In some embodiments, the motorized crushing apparatus may also include a TRIAC device that enables a phase range of the AC power source to output current to the motor driver and disables other phase of the AC power source not to output current to the motor driver.

In some embodiments, the controller uses the TRIAC device to control total energy level supplied to the motor driver according to the selected crushing pattern.

In some embodiments, the motor driver includes a phase control unit.

The phase control unit is coupled to the TRIAC signal to disable a certain phase range of the AC power source not to output to the motor.

In some embodiments, a schedule pattern corresponds to a series of duty ratios of power supplied to the motor over time.

A higher duty ratio corresponds to higher crushing force to the object in the container.

In some embodiments, a series of gap time periods are inserted into the series of duty ratios.

In some embodiments, the motorized crushing apparatus may also include a blocking detector coupled to the AC power source to detect when the motor is blocked during operation.

In some embodiments, the blocking detector is coupled to the controller.

When the controller determines a blocking occurs, the controller activates a de-blocking control signal corresponding to a schedule pattern trying to de-blocking the object in the container.

In some embodiments, the blocking detector detects a current variation during the operation of the motor.

The current variation is provided to the controller to fine-tune the control signal even under the same selected crushing pattern.

In some embodiments, the motorized crushing apparatus may also include a manual setting switch.

The user operates the manual setting switch to operate the motor to crush the object.

When the controller records the schedule pattern corresponding to the operation of the user with the manual setting switch.

In some embodiments, in future operation, the recorded schedule pattern is provided as an option among the multiple candidate crushing patterns.

In some embodiments, the object includes ice blocks.

In some embodiments, the container has water container area for temporarily storing melted ice water to decrease resistance for the motor caused by the melted ice water.

In some embodiments, the motorized crushing apparatus may also include a camera to detect the size of the crushed iced blocks.

The controller is coupled to the camera to determine an adjusted control signal supplied to the motor driver.

In some embodiments, the controller is coupled to an external device to receive a command.

The controller translate the command to generate a corresponding control signal.

In some embodiments, the external device is a mobile phone installed with an APP.

The APP generates the command based on a recipe.

The command is related to ice block size and shape.

The controller translates the command to determine how to generate the control signal to achieve the requested ice block size and shape.

In some embodiments, the motorized crushing apparatus may also include a ice tray for generating a standard size of ice blocks designed for the controller to generate the control signal.

In some embodiments, the motorized crushing apparatus may also include a mode switch.

When the user uses the ice tray to generate the standard size of ice blocks, the user turns on the switch to inform the control to perform corresponding processing.

In some embodiments, the motorized crushing apparatus may also include a microphone to collect a sound during operation of the motor.

The microphone is coupled to the controller for the controller to determine operation of the crushing based on the sound.

In some embodiments, the controller provides an operation status based on the sound via a display.

### BRIEF DESCRIPTION OF DRAWINGS

FIG. 1 illustrates an embodiment of a motorized crushing apparatus.

FIG. 2 illustrates an example circuit diagram of a component in the embodiment of FIG. 1.

FIG. 3 illustrates another diagram showing a combination of different circuits.

FIG. 4 illustrates a diagram of combination of components.

FIG. 5 illustrates a signal waveform diagram showing how control is performed in an embodiment.

FIG. 6 illustrates multiple schedule patterns.

FIG. 7 illustrates a circuit example illustrating how to implement a component.

FIG. 8 illustrates another motorized crushing apparatus embodiment.

FIG. 9 shows a circuit connection diagram.

FIG. 10 shows a component electric circuit design example.

FIG. 11 shows another circuit for a component design example.

FIG. 12 illustrates another motorized crushing apparatus.

### DETAILED DESCRIPTION

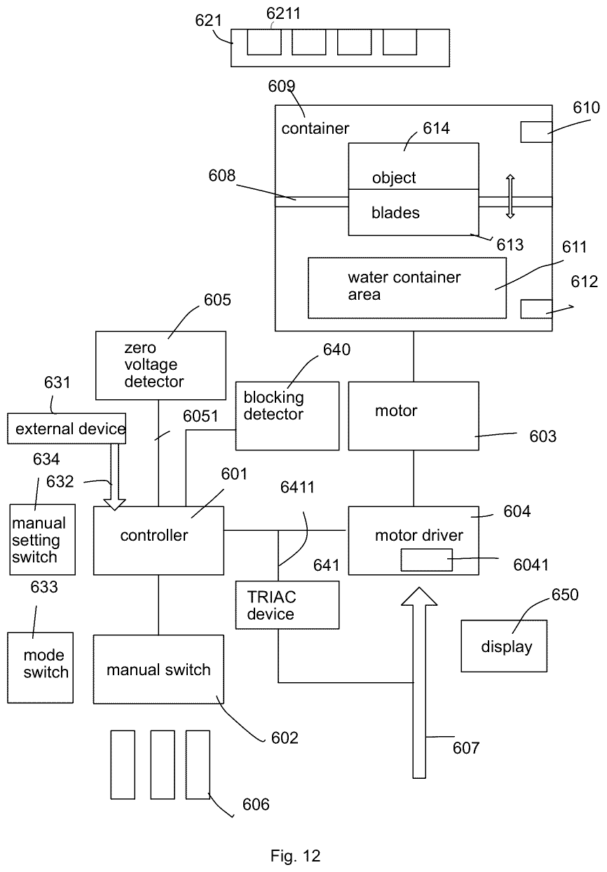

In FIG. 12, a motorized crushing apparatus includes a zero voltage detector 605, a manual switch 602, a motor driver 604, a motor 603 and a controller 601.

The zero voltage detector 605 is coupled to an AC power source 607.

When a varying voltage of the AC power source 607 is below zero, the zero voltage 605 detector generates a first signal at the position 6051 to the controller 601.

When the varying voltage of the AC power source 607 is above zero, the zero voltage detector 605 generates a non-zero signal at the position 6051.

Please note that electronic signal is invisible and the diagram of FIG. 12 show relation among components. Such arrangement does not limit the invention scope to a specific hardware design. Nevertheless, persons who are familiar with circuit design would understand how to implement a product based on such guidance.

The manual switch 602 is provided for a user to select a crushing pattern from multiple candidate crushing patterns 606. For example, there are three crushing patterns corresponding to three different sizes and shapes of ice blocks to be generated.

The motor driver 604 is coupled to the AC power source 607.

The motor 603 is coupled to the motor driver 604 to carrying a crushing device like a blade 613 or other structures to crush an object 614 in a container 609.

The controller is coupled to the zero voltage detector, the manual switch and the motor driver.

The controller 601 generates a control signal corresponding to the selected crushing pattern to alternatively turn on and turn off the motor driver 604 under a schedule pattern. The schedule pattern refers to a control pattern that varies over time which may include or do not include repeated patterns.

Different candidate crushing patterns correspond to different control signals of different schedule patterns for crushing the object into different sizes and shapes.

In some embodiments, the motorized crushing apparatus may also include a TRIAC device 641 that enables a phase range of the AC power source to output current to the motor driver and disables other phase of the AC power source not to output current to the motor driver.

A TRIAC (Triode for Alternating Current) is a semiconductor device that is widely used for controlling power in AC circuits. It operates by acting as a switch that can conduct current in both directions when triggered. Unlike a regular thyristor, which can only conduct in one direction, a TRIAC can manage alternating current, making it highly versatile for applications in power control, such as in light dimmers, motor speed controls, and heating regulation.

The operation of a TRIAC is based on its ability to control the phase angle of the AC waveform. When a TRIAC is triggered at a certain point during the AC cycle, it allows current to pass through only for the remainder of that cycle. By adjusting the point at which the TRIAC is triggered, it is possible to control the amount of power delivered to the load. This process is known as phase control. For instance, if the TRIAC is triggered halfway through the AC cycle, it will only conduct for the latter half, effectively cutting the power delivered to the load by half.

Phase control works by delaying the triggering of the TRIAC until a specific point in the AC cycle. This delay can be varied to adjust the amount of power delivered to the load. The control circuit for the TRIAC typically uses a timing mechanism to determine when to send the trigger pulse. By advancing or delaying this pulse within each AC cycle, the circuit can modulate the power output smoothly and efficiently. This method of power control is highly effective because it allows for continuous adjustment over a wide range of power levels without the need for dissipating excess energy as heat.

The ability to precisely control power through phase selection makes the TRIAC an excellent option for designing power adjustment switches. For example, in a light dimmer, the TRIAC can be triggered at different points in the AC cycle to vary the brightness of the light. This not only provides fine-grained control over lighting levels but also improves energy efficiency. Similarly, in motor speed controls, the TRIAC can adjust the power supplied to the motor, allowing for smooth changes in speed and torque.

In summary, the TRIAC is a powerful and flexible device for controlling AC power through phase selection. By varying the trigger point within each AC cycle, it can cut off a portion of the power, allowing for precise adjustments in power delivery. This makes the TRIAC an ideal component for power adjustment switches in a wide range of applications, from lighting and heating to motor speed control. Its ability to manage power efficiently and smoothly enhances the functionality and energy efficiency of the devices it controls.

In some embodiments, the controller uses the TRIAC device to control total energy level supplied to the motor driver according to the selected crushing pattern.

In some embodiments, the motor driver includes a phase control unit 6041.

The phase control unit 6041 is coupled to the TRIAC signal 6411 to disable a certain phase range of the AC power source not to output to the motor 603.

In the described system, the phase control unit plays a crucial role in managing the power delivered to the motor by selectively controlling the conduction periods of the TRIAC. By doing so, it effectively regulates the amount of electrical energy that reaches the motor, thereby adjusting its performance according to the desired operational parameters. This method of power control is essential for applications requiring precise modulation of motor speed and torque.

The phase control unit works by generating a control signal that determines the exact moments within the AC power cycle when the TRIAC should be turned on and off. The AC power cycle consists of alternating current that varies sinusoidally over time, typically completing a full cycle 50 or 60 times per second (depending on the regional power standard). The control unit calculates the optimal trigger points for the TRIAC to start and stop conducting, thereby disabling certain portions of the AC waveform from reaching the motor.

When the TRIAC is triggered at a specific point in the AC cycle, it begins to conduct electricity, allowing current to flow through to the motor. By delaying this trigger point, the phase control unit effectively reduces the duration within each cycle during which the TRIAC conducts. This delay corresponds to a reduction in the power supplied to the motor. For instance, if the TRIAC is triggered halfway through the positive half-cycle of the AC wave, only the latter half of the wave's power is delivered to the motor. This technique is known as phase-angle control.

The advantage of this method is that it provides a fine level of control over the power delivered to the motor without introducing significant losses or heat dissipation, which are common in resistive methods of power control. By selectively cutting off portions of the AC cycle, the system can modulate motor speed and torque efficiently, making it ideal for applications like fan speed controllers, light dimmers, and various types of motor-driven equipment.

Implementing this invention involves designing the phase control unit to synchronize with the AC power source and the TRIAC. The control unit must accurately detect the zero-crossing points of the AC waveform to determine the timing for generating the trigger signals. This synchronization ensures that the TRIAC is turned on and off at the precise moments needed to achieve the desired phase angle control.

Additionally, the system must account for the electrical characteristics of the motor and the load it drives. Different motors may require different phase angles to achieve the same power modulation effect. The phase control unit can be programmed or adjusted to accommodate these variations, ensuring optimal performance across a range of operating conditions.

In the context of ice crushing, this method of power control is particularly beneficial. Ice crushers require high torque at low speeds to effectively break down ice. By using phase control, the power delivered to the motor can be precisely adjusted to provide the necessary torque without overloading the motor or causing excessive wear. This ensures the ice crusher operates efficiently and with minimal maintenance.

In summary, the invention described provides a robust and efficient means of controlling power delivery to a motor by selectively disabling certain phases of the AC power source through phase-angle control. This technique enhances the versatility and performance of motor-driven devices while maintaining energy efficiency and reducing operational costs. By integrating a phase control unit with a TRIAC, the system achieves precise modulation of motor power, making it suitable for a wide range of applications, including those requiring variable speed and torque control.

In some embodiments, a schedule pattern corresponds to a series of duty ratios of power supplied to the motor over time.

A higher duty ratio corresponds to higher crushing force to the object in the container.

In some embodiments, a series of gap time periods are inserted into the series of duty ratios.

The concept of using a schedule pattern to control the duty ratios of power supplied to the motor introduces a sophisticated method of power modulation that enhances the performance and efficiency of the motor-driven device. Duty ratio, in this context, refers to the proportion of time within a given cycle that the motor is actively powered. By adjusting this ratio, the power and consequently the force exerted by the motor can be finely controlled to suit specific operational requirements.

In practice, a higher duty ratio means that the motor is powered for a longer duration within each cycle, resulting in greater energy being delivered to the motor. This increase in power translates to a higher crushing force being applied to the objects in the container. Such precise control is particularly beneficial in applications where the material being processed varies in hardness or density, allowing the device to adapt its crushing force dynamically to ensure efficient and effective operation.

To further refine the control over the motor's power delivery, embodiments may include a series of gap time periods interspersed within the duty ratios. These gap periods represent intervals where no power is supplied to the motor, effectively allowing the motor to rest. The introduction of these gaps can serve multiple purposes, such as preventing overheating of the motor, reducing wear and tear, and allowing time for the crushed material to settle, which can enhance the overall efficiency of the crushing process.

The implementation of a schedule pattern with varying duty ratios and gap periods enables a more tailored approach to motor control. For instance, in the initial stages of crushing harder materials, the system might employ higher duty ratios to exert maximum force. As the material begins to break down, the duty ratios can be decreased, and more gap periods can be introduced to avoid over-processing and conserve energy. This approach not only optimizes the crushing force applied at each stage but also extends the lifespan of the motor by preventing continuous high-load operation.

From a technical standpoint, the control system for managing these duty ratios and gap periods can be realized through a combination of hardware and software components. A microcontroller or digital signal processor (DSP) can be programmed to execute the schedule pattern, dynamically adjusting the power supply to the motor based on real-time feedback from sensors monitoring the motor's performance and the characteristics of the material being processed. This feedback loop ensures that the motor operates within optimal parameters, delivering the required force without exceeding its operational limits.

In addition to enhancing performance and durability, this method of power control can also contribute to energy efficiency. By precisely regulating the duty cycles and incorporating rest periods, the system minimizes unnecessary power consumption. This is particularly important in industrial applications where motors may operate continuously for extended periods. Efficient power management not only reduces operational costs but also aligns with energy conservation goals, making the device more environmentally friendly.

The ability to customize the schedule pattern for different materials and operational scenarios adds a layer of versatility to the device. For example, softer materials might require lower duty ratios and shorter gap periods, whereas harder materials would benefit from higher duty ratios and longer gap periods. This flexibility allows the same device to be used across a wide range of applications, enhancing its utility and market appeal.

Finally, it is worth noting that while this sophisticated control method is particularly advantageous for applications like ice crushing, it can be applied to any motor-driven process where precise control of power delivery is crucial. The principles of duty ratio modulation and scheduled gap periods can be adapted to various industries, from food processing to manufacturing, providing a robust solution for optimizing motor performance across diverse contexts.

In conclusion, the use of a schedule pattern with variable duty ratios and gap periods represents a significant advancement in motor control technology. By enabling precise modulation of power supply, this approach enhances the performance, efficiency, and longevity of motor-driven devices. Whether applied to ice crushing or other industrial processes, this method offers a flexible and efficient solution for managing motor power to achieve optimal results.

In some embodiments, the motorized crushing apparatus may also include a blocking detector 640 coupled to the AC power source to detect when the motor is blocked during operation.

In some embodiments, the blocking detector is coupled to the controller.

When the controller determines a blocking occurs, the controller activates a de-blocking control signal corresponding to a schedule pattern trying to de-blocking the object in the container.

In some embodiments, the blocking detector detects a current variation during the operation of the motor.

The current variation is provided to the controller to fine-tune the control signal even under the same selected crushing pattern.

A blocking detector is a crucial component in a motorized crushing apparatus, designed to enhance the functionality and safety of the device. When the motor drives blades to crush materials and encounters a blockage, the current variation in the power wire can indicate that a blockage has occurred. This variation in current can provide valuable information about the type and severity of the blockage, allowing the system to respond appropriately.

In some embodiments, the motorized crushing apparatus includes a blocking detector 640 that is coupled to the AC power source. This detector monitors the current supplied to the motor during operation. When the motor encounters a blockage, such as when an object obstructs the blades, the current drawn by the motor will change, typically increasing due to the added resistance. The blocking detector can sense these variations and signal that a blockage is occurring.

The blocking detector is also coupled to the controller of the apparatus. This connection allows the controller to receive real-time data about the motor's operating conditions. When the blocking detector signals a blockage, the controller can analyze the data to determine the nature of the blockage. Based on this analysis, the controller can activate a de-blocking control signal. This signal corresponds to a schedule pattern designed to alleviate the blockage by adjusting the motor's operation, such as reversing the motor's direction or modulating the power to dislodge the obstruction.

In some embodiments, the blocking detector detects variations in current during the motor's operation. These current variations are critical for the controller to fine-tune the control signals. Even under the same selected crushing pattern, the controller can adjust the motor's behavior dynamically to address the specific blockage encountered. This fine-tuning ensures that the motor operates efficiently and effectively, minimizing downtime and maintaining consistent performance.

The integration of a blocking detector with the controller provides a sophisticated level of operational intelligence to the motorized crushing apparatus. The ability to detect blockages and respond in real-time enhances the device's reliability and safety. By continuously monitoring the current and adjusting the motor's operation as needed, the system can prevent damage to the motor and blades, extending the lifespan of the apparatus.

Moreover, the use of a blocking detector and adaptive control signals ensures that the apparatus can handle a variety of materials and blockage scenarios. Whether crushing ice, nuts, or other hard materials, the system can detect and respond to blockages quickly and effectively. This adaptability makes the motorized crushing apparatus more versatile and capable of delivering consistent results across different applications.

In some cases, the blocking detector can also provide diagnostic data that helps in maintenance and troubleshooting. By analyzing the current patterns and identifying recurring blockages, users can gain insights into potential issues with the apparatus or the materials being processed. This information can guide preventive maintenance efforts, reducing the likelihood of unexpected failures and ensuring smooth operation.

Overall, the inclusion of a blocking detector in the motorized crushing apparatus represents a significant advancement in the design and functionality of these devices. By coupling the detector with the controller and employing adaptive control signals, the system can effectively manage blockages and maintain optimal performance. This innovation not only improves the user experience but also enhances the durability and efficiency of the apparatus.

In conclusion, the blocking detector plays a pivotal role in the motorized crushing apparatus by monitoring current variations and signaling blockages to the controller. The controller, in turn, activates de-blocking control signals based on the detected conditions, ensuring that the motor operates smoothly and efficiently. This integrated approach provides a robust solution for handling blockages, making the motorized crushing apparatus more reliable, versatile, and user-friendly.

In some embodiments, the motorized crushing apparatus may also include a manual setting switch 634.

The user operates the manual setting switch 634 to operate the motor to crush the object.

When the controller records the schedule pattern corresponding to the operation of the user with the manual setting switch.

In some embodiments, in future operation, the recorded schedule pattern is provided as an option among the multiple candidate crushing patterns.

The user operates the manual setting switch 634 to adjust the motor to various power levels and durations. For example, the user may set the motor to its strongest level for 1 second, then reduce it to minimal speed for 2 seconds, before increasing it again to the strongest level for 4 seconds, and finally, settling at a medium level for 10 seconds. This sequence of operations, or schedule pattern, reflects the user's preferred method for processing a particular type of material or achieving a specific texture.

When the controller records the schedule pattern corresponding to the operation of the user with the manual setting switch, it captures the exact sequence of power levels and timings. This recording process ensures that the controller accurately stores the user's customized crushing pattern, which can then be retrieved and used in future operations. The capability to record and recall specific patterns adds a layer of personalization and convenience, enhancing the overall user experience.

In some embodiments, in future operation, the recorded schedule pattern is provided as an option among the multiple candidate crushing patterns. This means that users can select their previously recorded custom pattern from a menu of preset options, allowing them to replicate the exact crushing process without needing to manually adjust the settings each time. This feature not only saves time but also ensures consistency in the results, particularly useful for users who regularly process similar materials.

The integration of a manual setting switch and the ability to record and recall custom patterns significantly enhances the functionality of the motorized crushing apparatus. Users gain the flexibility to experiment with different settings and find the optimal pattern for their needs, which can then be saved and reused effortlessly. This adaptability makes the apparatus more versatile and user-friendly, catering to both novice and experienced users.

Additionally, the recorded patterns can be particularly useful in professional or commercial settings where consistent results are crucial. For instance, a chef or a barista might develop specific patterns for preparing ingredients or beverages, ensuring that each batch meets the same high standards. By selecting the custom pattern, they can achieve this consistency without needing to supervise the process closely each time.

The controller's ability to store multiple custom patterns also allows for easy switching between different processing tasks. Users can create and save patterns for various materials, such as ice, fruits, or nuts, and select the appropriate pattern depending on the task at hand. This multi-functionality makes the motorized crushing apparatus a valuable tool in diverse kitchen and industrial applications.

Moreover, the manual setting switch combined with the recording feature can serve as an educational tool. Users can learn from their previous experiments by reviewing the recorded patterns and understanding which settings produce the best results for different materials. This iterative learning process can help users become more proficient in using the apparatus and more knowledgeable about the materials they are processing.

The system's ability to adapt to user preferences also means that it can accommodate a wide range of materials and processing techniques. Whether a user needs a coarse chop or a fine puree, the recorded patterns can be tailored to deliver the desired outcome. This level of customization ensures that the motorized crushing apparatus meets a broad spectrum of user needs, making it a versatile addition to any kitchen or workspace.

In some embodiments, the object includes ice blocks.

In some embodiments, the container has water container area 6111 for temporarily storing melted ice water to decrease resistance for the motor caused by the melted ice water.

When ice block is in the water, the resistance to crush the ice blocks is different from isolating the ice blocks away from melted water. An adjustment structure 608 may change the location of the blades 613 to different levels to create a different size of water container area 611 to achieve that.

In some embodiments, the container has a water container area 6111 for temporarily storing melted ice water to decrease the resistance for the motor caused by the melted ice water. This design consideration acknowledges that the presence of water can significantly affect the efficiency of the crushing process. By providing a designated area for the water to collect, the apparatus can ensure that the ice blocks remain relatively isolated from the melted water, thereby reducing the resistance that the motor encounters during operation.

When ice blocks are submerged in water, the resistance to crushing them can differ significantly compared to when the ice blocks are isolated from the melted water. The water can create additional drag and increase the effort required by the motor to crush the ice effectively. To address this, the apparatus includes an adjustment structure 608 that allows the user to change the position of the blades 613 to different levels within the container. This adjustment capability enables the creation of different sizes of the water container area 611, optimizing the crushing conditions based on the amount of melted water present.

The adjustment structure 608 provides a versatile solution for managing the dynamics of ice crushing. By altering the location of the blades, users can customize the apparatus to handle varying amounts of melted ice water, ensuring that the motor operates under optimal conditions. This adaptability is particularly useful in scenarios where large quantities of ice are being processed, and the amount of melted water can fluctuate significantly during the operation.

Furthermore, the ability to modify the water container area 6111 enhances the overall efficiency of the motorized crushing apparatus. By reducing the resistance caused by the melted water, the motor can perform more effectively, leading to smoother operation and potentially extending the lifespan of the motor. This design consideration not only improves the performance of the apparatus but also contributes to its durability and reliability.

In addition to enhancing motor efficiency, the adjustable water container area can also improve the quality of the crushed ice. By minimizing the interaction between the ice blocks and the melted water, the apparatus can produce more uniformly crushed ice, which is desirable for various applications, such as in beverages or food preparation. This feature ensures that the end product meets the high standards expected by users, whether in a commercial or domestic setting.

The inclusion of the adjustment structure 608 and the water container area 6111 demonstrates a thoughtful approach to the design of the motorized crushing apparatus. It highlights the importance of considering the physical properties of the materials being processed and the impact of those properties on the operation of the device. By addressing these factors, the apparatus can deliver superior performance and user satisfaction.

Moreover, the design flexibility offered by the adjustment structure means that the apparatus can be tailored to a wide range of operational scenarios. Users can easily adjust the blade position to accommodate different volumes of ice and water, ensuring that the apparatus remains effective and efficient regardless of the specific conditions. This versatility makes the motorized crushing apparatus a valuable tool in various environments, from home kitchens to professional settings.

Overall, the ability to manage the water content and adjust the blade position within the container significantly enhances the functionality of the motorized crushing apparatus. This feature allows users to optimize the crushing process, reduce motor resistance, and achieve high-quality results consistently. The thoughtful integration of these elements underscores the innovation behind the design, ensuring that the apparatus meets the diverse needs of its users.

In some embodiments, the motorized crushing apparatus may also include a camera 610 to detect the size of the crushed iced blocks.

The controller is coupled to the camera to determine an adjusted control signal supplied to the motor driver.

In some embodiments, the motorized crushing apparatus may also include a camera 610 to detect the size of the crushed ice blocks. The integration of a camera provides a visual input to the system, allowing it to gather real-time data on the ice blocks within the container. This capability enhances the apparatus's ability to adjust its operation based on the observed characteristics of the ice, such as size and distribution.

The controller is coupled to the camera to determine an adjusted control signal supplied to the motor driver. By analyzing the images captured by the camera, the controller can assess the current state of the ice blocks and make informed decisions on how to modulate the motor's performance. This process involves interpreting the visual data to identify the size, shape, and distribution of the ice, enabling precise adjustments to the crushing mechanism.

Leveraging AI technology, the motorized crushing apparatus can significantly enhance its efficiency and effectiveness. Machine learning algorithms can be trained to recognize various ice block configurations and predict the optimal crushing patterns. These algorithms analyze the visual data from the camera, classify the ice blocks based on their dimensions and shapes, and determine the best approach for crushing them efficiently. This intelligent system ensures that the motor operates at optimal power levels, reducing unnecessary strain and improving the overall quality of the crushed ice.

The use of AI for object recognition and size determination allows the apparatus to adapt dynamically to different conditions. For example, if the camera detects larger ice blocks, the controller can adjust the motor to apply more force or modify the crushing pattern to handle the increased load. Conversely, if smaller ice fragments are detected, the system can reduce the motor power to prevent over-crushing and ensure a uniform consistency. This adaptability enhances the user experience by delivering consistent results regardless of the initial state of the ice.

Furthermore, the AI-driven analysis can provide valuable insights into the efficiency of the crushing process. By continuously monitoring the ice blocks and adjusting the motor's performance, the system can optimize energy usage and reduce wear on the mechanical components. This predictive maintenance capability helps extend the lifespan of the apparatus and ensures reliable operation over time.

Incorporating AI technology also opens up possibilities for advanced features such as automated mode selection and performance feedback. Users can benefit from an apparatus that not only adjusts its settings in real-time but also learns from previous usage patterns to improve future performance. For instance, the system can remember specific user preferences and adapt its operation to match those preferences, making the crushing process more intuitive and personalized.

Additionally, the integration of AI and camera-based detection can enhance the safety features of the apparatus. The system can recognize potential issues, such as foreign objects or unexpected blockages, and respond appropriately to prevent damage or injury. This proactive approach to safety ensures that the apparatus operates smoothly and reduces the risk of accidents.

The combination of a camera and AI technology represents a significant advancement in the design of motorized crushing apparatus. It transforms the device from a simple mechanical tool into an intelligent system capable of adapting to various conditions and user needs. This innovation not only improves the performance and reliability of the apparatus but also sets a new standard for convenience and user satisfaction in the realm of kitchen appliances.

Overall, the implementation of AI technology for identifying ice block objects and determining their sizes and shapes enhances the functionality and efficiency of the motorized crushing apparatus. By providing real-time data and intelligent control, the system ensures optimal performance, consistent results, and a superior user experience. The integration of these advanced technologies underscores the potential for continuous improvement and innovation in the design of household and commercial appliances.

In some embodiments, the controller is coupled to an external device 631 like a mobile phone to receive a command 632.

The controller translates the command to generate a corresponding control signal.

In some embodiments, the external device is a mobile phone installed with an APP.

The APP generates the command based on a recipe.

The command is related to ice block size and shape.

The controller translates the command to determine how to generate the control signal to achieve the requested ice block size and shape.

In some embodiments, the controller is coupled to an external device 631 like a mobile phone to receive a command 632. This integration allows users to remotely control the motorized crushing apparatus, enhancing convenience and flexibility. The external device sends commands that are distinct from the usual control signals generated within the apparatus. These commands are more akin to instructions or targets that the system needs to achieve, requiring a different approach to processing and execution.

When the controller receives a command from the external device, it interprets this input as an instruction to achieve a specific outcome. Rather than directly controlling the motor's speed or power, the command specifies a desired result, such as a particular ice block size and shape. The controller uses its internal data and pre-stored rules to translate this high-level command into a series of control signals that can drive the motor and adjust the crushing mechanism accordingly.

In some embodiments, the external device is a mobile phone installed with an APP. The APP serves as the user interface, allowing the user to select from various predefined recipes or create custom commands. These recipes can include specific parameters for the ice crushing process, such as the size and consistency of the ice blocks required for different beverages or culinary applications. The APP generates the command based on these inputs, which is then sent to the controller.

The command from the APP is related to the ice block size and shape, indicating the desired final product. For example, a user might select a setting for finely crushed ice for cocktails or larger, coarser chunks for a different application. The controller must translate this command into actionable control signals that will adjust the motor's operation and the position of the blades to achieve the specified ice characteristics. This involves using data about the current state of the ice and the apparatus's capabilities to determine the optimal settings.

The controller's ability to translate high-level commands into precise control signals is crucial for achieving the desired outcomes. It relies on sophisticated algorithms and a database of pre-stored rules that dictate how to handle various scenarios. These rules encompass the relationships between motor speed, blade position, and the resulting ice properties. By referencing these rules, the controller can generate a control signal sequence that adjusts the apparatus's operation in real-time, ensuring that the user's command is accurately fulfilled.

This approach provides several advantages. Firstly, it simplifies the user experience by abstracting the complexity of motor control into straightforward commands. Users do not need to understand the technical details of how the apparatus operates; they only need to specify what they want, and the system takes care of the rest. This makes the device more accessible and user-friendly, appealing to a broader range of consumers.

Secondly, the ability to use an external device like a mobile phone for input expands the functionality of the motorized crushing apparatus. It allows for remote operation, enabling users to control the device from anywhere within their home or even outside, as long as they have a connection. This flexibility is particularly useful in busy kitchen environments or for users who enjoy entertaining and want to prepare drinks or crushed ice ahead of time.

Moreover, the integration with mobile devices and apps opens up possibilities for future enhancements. For example, the APP could be updated to include new recipes or advanced features such as voice control, integration with smart home systems, or even AI-driven recommendations based on user preferences and past usage patterns. This ensures that the motorized crushing apparatus remains up-to-date with the latest technological advancements, continually improving its functionality and user experience.

The ability to translate commands from an external device into precise control signals also enhances the consistency and quality of the crushed ice. By following predefined rules and using real-time data, the controller can ensure that the ice meets the specified standards every time, regardless of variations in input or operating conditions. This reliability is crucial for applications where consistent ice quality is essential, such as in professional bars and restaurants.

Overall, the integration of an external device like a mobile phone to send commands to the motorized crushing apparatus represents a significant advancement in user interface design and operational flexibility. By interpreting these commands as targets and using sophisticated algorithms to generate the corresponding control signals, the system can achieve precise and consistent results, enhancing both the convenience and the performance of the apparatus.

In some embodiments, the motorized crushing apparatus may also include a ice tray 621 for generating a standard size of ice blocks 6211 designed for the controller to generate the control signal.

In some embodiments, the motorized crushing apparatus may also include a mode switch 633.

When the user uses the ice tray to generate the standard size of ice blocks, the user turns on the switch to inform the control to perform corresponding processing.

In some embodiments, the motorized crushing apparatus may also include a microphone 612 to collect a sound during operation of the motor.

The microphone 612 is coupled to the controller for the controller to determine operation of the crushing based on the sound.

In some embodiments, the controller provides an operation status based on the sound via a display 650.

In some embodiments, the motorized crushing apparatus may also include a microphone 612 to collect sound during the operation of the motor. Integrating a microphone into the apparatus allows for an additional layer of sensory input, enabling the system to monitor the acoustic signals generated during the crushing process. The sounds produced by the motor and the crushing mechanism can provide valuable insights into the operational status and efficiency of the apparatus.

The microphone 612 is coupled to the controller, allowing the controller to analyze the sounds captured during operation. By processing these audio signals, the controller can detect anomalies or patterns that indicate the current state of the crushing process. For instance, certain frequencies or sound levels might correspond to optimal operation, while others could indicate potential issues such as blockages, motor strain, or mechanical wear. The ability to interpret these sounds enables the controller to make real-time adjustments to maintain efficient and effective crushing.

In some embodiments, the controller uses the collected sound data to provide an operation status via a display 650. The display can present a variety of information derived from the acoustic analysis, such as the current performance of the motor, the condition of the blades, and the progress of the crushing process. By offering visual feedback based on sound, the apparatus helps users understand how it is operating and whether any adjustments or maintenance might be needed.

The incorporation of sound analysis into the motorized crushing apparatus enhances its diagnostic capabilities. For example, the controller might detect an unusual grinding noise that signals a blockage, prompting it to initiate a de-blocking procedure automatically. Alternatively, it might recognize a high-pitched whine indicative of motor strain, leading it to reduce power temporarily to prevent overheating. These proactive measures ensure the apparatus continues to function smoothly and prolong its operational life.

Using sound to monitor operation also provides a non-invasive method for ensuring the apparatus is working correctly. Unlike visual or tactile sensors, a microphone does not require direct contact with the ice or the motor components, reducing wear and maintenance requirements. This passive monitoring approach leverages the natural byproducts of the crushing process—sound waves—to gather information, making it a highly efficient and effective diagnostic tool.

Furthermore, the feedback provided via the display based on sound analysis can be highly informative for users. For instance, the display might show messages like “Optimal Operation,” “Potential Blockage Detected,” or “Motor Strain-Reduce Load.” Such feedback helps users take appropriate actions, such as adding less ice, checking for obstructions, or performing routine maintenance, thereby improving the overall user experience and ensuring consistent performance.

Integrating sound analysis also opens the door to advanced features such as predictive maintenance. By continuously monitoring the sounds produced during operation, the system can build a database of acoustic signatures associated with different operational states. Over time, machine learning algorithms can be employed to predict potential failures before they occur, allowing for timely intervention and reducing downtime.

In a commercial setting, where reliability and efficiency are paramount, the ability to monitor and respond to operational sounds can significantly enhance the value of the motorized crushing apparatus. Businesses can rely on the apparatus to provide consistent results while minimizing the risk of unexpected breakdowns, which can disrupt service and incur costs.

Additionally, the use of sound analysis for operational feedback can make the apparatus more accessible to a wider range of users. For those less familiar with the technical aspects of the machine, simple and clear messages on the display can guide them in using the apparatus effectively and safely. This user-friendly approach ensures that even novice users can operate the device with confidence.

Overall, the integration of a microphone for sound collection and analysis, coupled with visual feedback via a display, represents a significant enhancement in the functionality and user-friendliness of the motorized crushing apparatus. This innovative approach leverages acoustic data to provide real-time diagnostics and operational feedback, ensuring optimal performance and improving the user experience.

In some embodiments, the microphone 612 used for collecting sound during the operation of the motorized crushing apparatus can be replaced with a vibration sensor. Since sound is essentially a type of vibration transmitted through the air, a vibration sensor can effectively capture similar data directly from the machine's structure. Vibration sensors are highly sensitive to the mechanical oscillations produced during motor operation and crushing, making them a suitable alternative for monitoring the apparatus's performance.

Vibration sensors offer several advantages over traditional microphones. They can detect a broader range of frequencies and are less susceptible to external noise interference, providing more accurate and reliable data. By measuring the vibrations within the apparatus itself, these sensors can capture detailed information about the operational state and identify potential issues that might not be evident through acoustic monitoring alone. This makes them particularly useful in noisy environments where microphones might struggle to isolate relevant sounds.

The integration of a vibration sensor can enhance the blocking detection capabilities of the motorized crushing apparatus. When the motor encounters a blockage, the resulting mechanical resistance produces distinct vibration patterns. By analyzing these patterns, the controller can accurately identify the occurrence and nature of the blockage. This method allows for precise and timely interventions, ensuring that the motor operates smoothly and efficiently.

Furthermore, the use of vibration sensors can facilitate the implementation of advanced diagnostic techniques, such as neural networks. Neural networks can be trained to recognize specific vibration patterns associated with different operational states, including normal operation, blockages, and mechanical wear. By learning these patterns, the neural network can provide real-time feedback to the controller, enabling it to adjust the motor's performance and address any issues proactively.

Creating neural networks to analyze vibration data involves collecting extensive datasets of the apparatus's vibrations under various conditions. These datasets are then used to train the neural network to distinguish between different patterns. Once trained, the neural network can predict the operational state of the apparatus with high accuracy, allowing for continuous monitoring and optimization of the crushing process.

The ability to replace microphones with vibration sensors and utilize neural networks for pattern recognition offers significant benefits for the motorized crushing apparatus. This approach enhances the precision and reliability of the monitoring system, ensuring that the apparatus operates at peak performance. Additionally, it provides a robust framework for detecting and addressing potential issues before they lead to more significant problems.

Incorporating vibration sensors and neural networks into the apparatus also supports the development of predictive maintenance strategies. By continuously monitoring vibration patterns, the system can identify early signs of wear and tear, allowing for maintenance to be scheduled before a failure occurs. This proactive approach minimizes downtime and extends the lifespan of the apparatus, providing long-term value to users.

Moreover, the combination of vibration sensors and neural networks can improve the user experience by providing detailed, actionable feedback. Users can receive notifications and recommendations based on the analysis of vibration data, helping them to operate the apparatus more effectively and efficiently. This level of insight ensures that the apparatus consistently delivers high-quality results.

The flexibility of using either microphones or vibration sensors allows for customization based on specific use cases and environments. For instance, in a quiet kitchen setting, a microphone might be sufficient, while in a bustling commercial environment, a vibration sensor would provide more reliable data. This adaptability ensures that the motorized crushing apparatus can meet the needs of a wide range of users and applications.

In addition to enhancing the functionality of the apparatus, the use of vibration sensors and neural networks represents a significant step forward in the integration of smart technologies into household and commercial appliances. These innovations leverage cutting-edge data analysis and machine learning techniques to deliver superior performance and user convenience.

Overall, the replacement of microphones with vibration sensors and the implementation of neural networks for sound pattern recognition mark a substantial advancement in the design and operation of the motorized crushing apparatus. These technologies provide a robust and flexible solution for monitoring and optimizing the performance of the apparatus, ensuring that it meets the highest standards of efficiency and reliability.

As summer approaches, people enjoy cooling down with milkshakes, smoothies, cocktails, and shaved ice. The ice used in these beverages or shaved ice can be produced by ice crushers.

In the current technology, the specifications of the ice used in different beverages or shaved ice vary. The ice crushers currently available on the market have a single function, offering only one type of ice crushing mode. They cannot provide ice in multiple specifications, thus failing to meet users' various ice crushing needs.

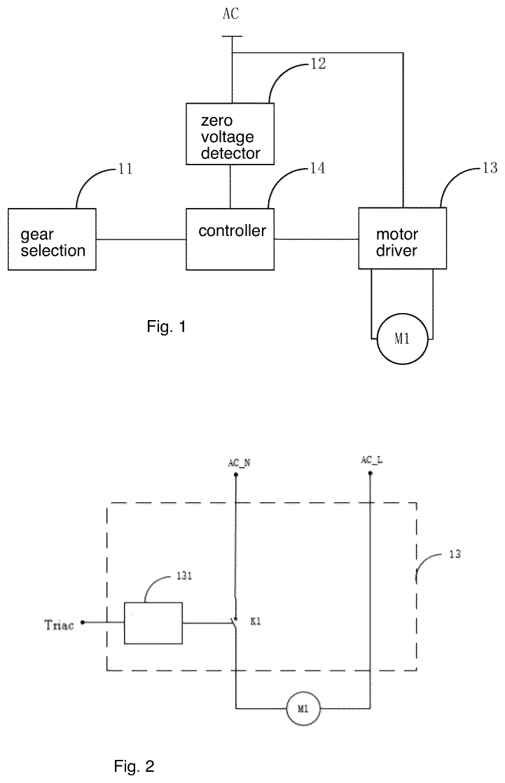

FIG. 1 is a schematic diagram of the control circuit structure of an ice crusher provided by an embodiment of the present utility model.

Referring to FIG. 1, the ice crusher control circuit includes: motor M1, gear selection module 11, zero-crossing detection module 12, motor drive module 13, and main control module 14.

The input end of the zero-crossing detection module 12 is used to connect with the AC power source, and the output end of the zero-crossing detection module 12 is connected to the main control module 14. It is used to detect the zero-crossing signal of the AC power source and send it to the main control module 14.

The gear selection module 11 as a manual switch is connected to the main control module 14 and is used to send gear signals to the main control module 14.

The input end of the motor drive module 13 is used to connect with the AC power source. The control end of the motor drive module 13 is connected to the main control module 14, and the output end of the motor drive module 13 is connected to motor M1 to drive motor M1.

In the embodiment of the present utility model, the zero-crossing detection module 12 is used to detect the zero-crossing signal of the AC power source and send the zero-crossing signal to the main control module 14. The main control module 14 outputs a drive control signal to the motor drive module 13 based on the zero-crossing signal of the AC power source to perform phase-cutting control, adjusting the output power of the motor drive module 13. At the same time, the embodiment of the present utility model also includes a gear selection module 11, which can be equipped with buttons or switches for selecting different gears through buttons or switches. The gear selection module 11 sends the gear signal to the main control module 14. The main control module 14 combines the zero-crossing signal and the gear signal to control the motor drive module 13 to drive motor M1 to operate in different modes, achieving various ice crushing effects to meet user needs.

In a possible embodiment, referring to FIG. 2, the input end of the motor drive module 13 may include: a first AC input end and a second AC input end; the first AC input end and the second AC input end are respectively connected to the neutral line (AC_N) and live line (AC_L) of the AC power source. The output end of the motor drive module 13 may include: a first drive end and a second drive end; the first drive end and the second drive end are respectively connected to the two ends of motor M1.

The motor drive module 13 may include: phase-cutting switch K1 and phase-cutting control unit 131.

The first end of the phase-cutting control unit 131 is connected to the control end of the motor drive module 13, and the second end of the phase-cutting control unit 131 is connected to the control end of the phase-cutting switch K1.

The phase-cutting switch K1 is connected in series between the first AC input end and the first drive end; the second AC input end is connected to the second drive end.

The phase-cutting control unit 131 is used to generate a phase-cutting control signal to control the phase-cutting switch K1. When the phase-cutting switch K1 is closed, motor M1 is powered on; when the phase-cutting switch K1 is open, motor M1 is powered off. Phase-cutting control of motor M1 is achieved by controlling the on-off state of the phase-cutting switch K1.

It should be noted that the first AC input end and the second AC input end are respectively connected to the neutral line (AC_N) and live line (AC_L) of the AC power source. Specifically, the first AC input end can be connected to the neutral line (AC_N) of the AC power source, and the second AC input end can be connected to the live line (AC_L) of the AC power source; or the second AC input end can be connected to the neutral line (AC_N) of the AC power source, and the first AC input end can be connected to the live line (AC_L) of the AC power source. Since the power source is AC, the specific connection direction is not limited.

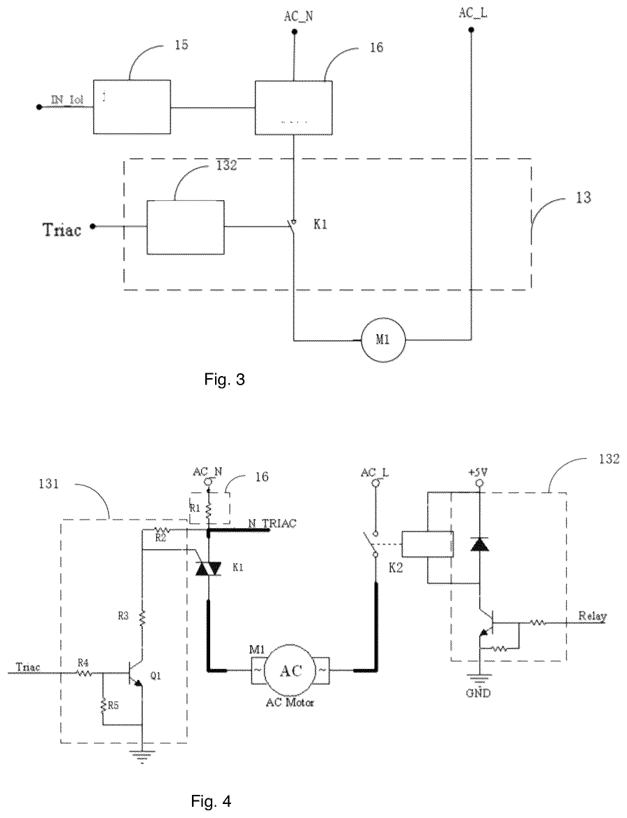

In a possible embodiment, referring to FIG. 3, the control circuit may also include: a stall detection module 15 and a current sampling module 16.

The current sampling module 16 can be connected in series with the phase-cutting switch K1 between the first AC input end and the first drive end; or the current sampling module 16 can be connected in series between the second AC input end and the second drive end.

The first end of the stall detection module 15 is connected to the current sampling module 16, and the second end of the stall detection module 15 is connected to the main control module 14, used to detect the current flowing through motor M1.

The current sampling module 16 is connected in series in the power supply circuit of motor M1, used to sample the current flowing through motor M1 and send the sampling signal to the stall detection module 15. The stall detection module 15 determines the current flowing through motor M1 based on the sampling signal and determines whether motor M1 is stalled based on the current. When a stall is detected in motor M1, it promptly controls motor M1 to stop, avoiding the motor stalling during low-speed operation, which could burn out the motor, thereby improving the safety of the ice crusher.

In a possible embodiment, referring to FIG. 3 and FIG. 4, the current sampling module 16 may include: a first resistor R1.

The first end of the first resistor R1 is connected to the first AC input end, and the second end of the first resistor R1 is respectively connected to the first end of the phase-cutting switch and the first end of the stall detection module 15.

The first end of the first resistor R1 is connected to the second AC input end, and the second end of the first resistor R1 is respectively connected to the second drive end and the first end of the stall detection module 15.

In this embodiment, the utility model uses a resistor to sample the current flowing through motor M1. The first resistor R1 is connected in series between the first AC input end and motor M1, or between the second AC input end and motor M1, without limitation. The stall detection module 15 obtains the voltage drop across the first resistor R1 and determines the current flowing through the motor based on the voltage drop, providing a low-cost and simple structure.

In a possible embodiment, referring to FIG. 4, the first end of the first resistor R1 is connected to the first AC input end, and the second end of the first resistor R1 is respectively connected to the first end of the phase-cutting switch K1 and the first end of the stall detection module 15; the second end of the phase-cutting switch K1 is connected to the first drive end.

The phase-cutting control unit 131 may include: a first switch transistor Q1, a second resistor R2, a third resistor R3, a fourth resistor R4, and a fifth resistor R5.

The first end of the first switch transistor Q1 is connected to the second end of the phase-cutting control unit 131 and the first end of the second resistor R2 through the third resistor R3, and the second end of the first switch transistor Q1 is grounded. The control end of the first switch transistor Q1 is connected to the first end of the fourth resistor R4 and the first end of the fifth resistor R5.

The second end of the fourth resistor R4 is connected to the first end of the phase-cutting control unit 131.

The second end of the second resistor R2 is connected to the second end of the first resistor R1 and the first end of the phase-cutting switch K1.

The second end of the fifth resistor R5 is grounded.

Referring to FIG. 4, this embodiment of the utility model uses a switch transistor to control the phase-cutting switch K1. The control signal of the phase-cutting switch K1 is generated by switching the first switch transistor Q1 on and off, achieving the control of the phase-cutting switch K1. The specific principle is not elaborated here.

Exemplarily, referring to FIG. 4, the first switch transistor Q1 may be an NPN-type transistor.

In a possible embodiment, referring to FIG. 4, the phase-cutting switch K1 may be a thyristor.

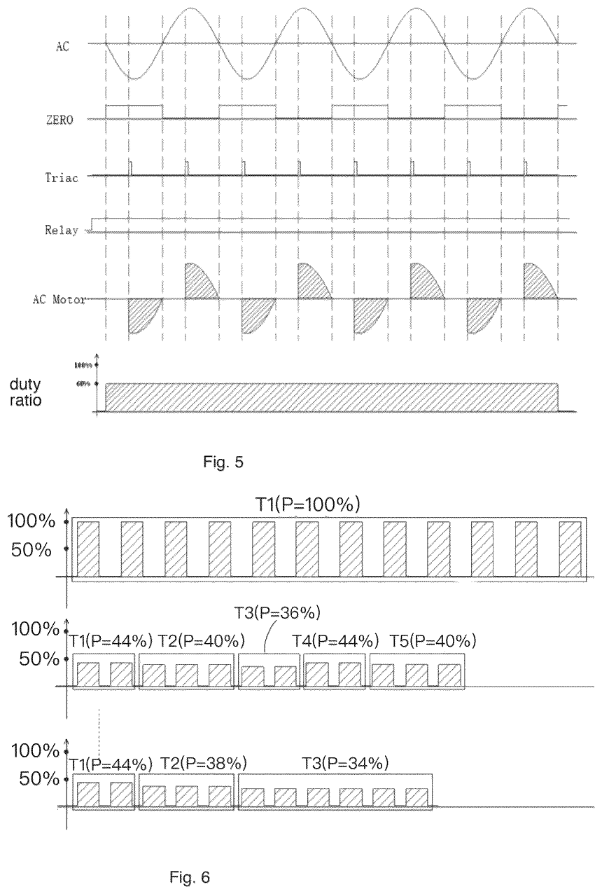

The phase-cutting switch K1 can be a thyristor. The zero-crossing detection module 12 outputs a zero-crossing signal (ZERO). Referring to FIG. 4, after a preset delay, the main control module 14 outputs a drive control signal (Triac). Referring to FIG. 4, Triac can be a pulse signal. When the pulse is high, the thyristor (phase-cutting switch K1) is conductive. Based on the characteristics of the thyristor, it turns off at the zero-crossing point of the AC power, providing the drive signal (AC Motor) for motor M1. Specifically, the preset delay can be determined according to the phase-cutting duty cycle, thereby adjusting the phase-cutting duty cycle to control the motor power duty cycle. For example, in FIG. 5, the motor power duty cycle is 60%.

Specifically, FIG. 6 shows the power duty cycle waveforms in three different modes.

Mode 1: The motor power duty cycle is 100%, running for 1 second, stopping for 1 second, repeated 12 times; refer to waveform 1 in FIG. 6.

Mode 2: Divided into 4 stages; the first stage, the motor power duty cycle is 44%, running for 1 second, stopping for 0.5 seconds, repeated twice; the second stage, the motor power duty cycle is 40%, running for 1 second, stopping for 0.5 seconds, repeated three times; the third stage, the motor power duty cycle is 36%, running for 1 second, stopping for 0.5 seconds, repeated twice; the fourth stage, the motor power duty cycle is 44%, running for 1 second, stopping for 0.5 seconds, repeated twice; the fifth stage, the motor power duty cycle is 40%, running for 1 second, stopping for 0.5 seconds, repeated three times; refer to waveform 2 in FIG. 6.

Mode 3: Divided into 3 stages; the first stage, the motor power duty cycle is 44%, running for 1 second, stopping for 0.5 seconds, repeated twice; the second stage, the motor power duty cycle is 38%, running for 1 second, stopping for 0.5 seconds, repeated three times; the third stage, the motor power duty cycle is 34%, running for 1 second, stopping for 0.5 seconds, repeated six times; refer to waveform 3 in FIG. 6.

The specific modes are not limited to the above three and can be set according to actual application needs.

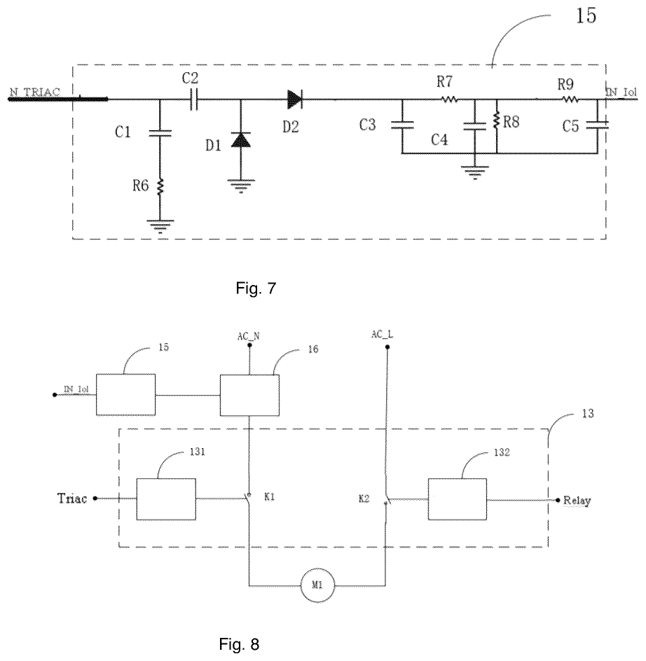

In a possible embodiment, referring to FIG. 7, the stall detection module 15 may include: first diode D1, second diode D2, first capacitor C1, second capacitor C2, third capacitor C3, fourth capacitor C4, fifth capacitor C5, sixth resistor R6, seventh resistor R7, eighth resistor R8, and ninth resistor R9.

The first end of the second capacitor C2 is connected to the first end of the stall detection module 15 and the first end of the first capacitor C1, respectively. The second end of the second capacitor C2 is connected to the cathode of the first diode D1 and the anode of the second diode D2.

The cathode of the second diode D2 is connected to the first end of the third capacitor C3 and the first end of the seventh resistor R7.

The second end of the seventh resistor R7 is connected to the first end of the fourth capacitor C4, the first end of the eighth resistor R8, and the first end of the ninth resistor R9, respectively.

The second end of the ninth resistor R9 is connected to the first end of the fifth capacitor C5 and the second end of the stall detection module 15, respectively.

The second end of the first capacitor C1 is grounded through the sixth resistor R6.

The anode of the first diode D1, the second end of the third capacitor C3, the second end of the fourth capacitor C4, the second end of the eighth resistor R8, and the second end of the fifth capacitor C5 are all grounded.

Specifically, the stall detection module 15 detects the current flowing through motor M1 in combination with the first resistor R1 through the aforementioned circuit. The main control module 14 determines whether motor M1 is stalled based on the principle that the startup current and stall current of the motor are similar and takes appropriate measures if motor M1 is stalled.

For example, it can directly control motor M1 to stop, or it can increase the duty cycle of motor M1 to increase power and help motor M1 overcome the stall. Alternatively, if increasing the power duty cycle of motor M1 multiple times still does not resolve the stall, it can control motor M1 to stop. The specific control method is not limited to these examples.

In a possible embodiment, referring to FIG. 8, the motor drive module 13 may also include: a main motor control switch K2 and a main control unit 132.

The main motor control switch K2 is connected in series between the second AC input end and the second drive end.

The control end of the main motor control switch K2 is connected to the first end of the main control unit 132.

The second end of the main control unit 132 is connected to the main control module 14.

In this embodiment, to improve the safety of the circuit, the main motor control switch K2 can be set in the AC power supply path of motor M1. By controlling the on-off state of the main motor control switch K2, the power supply path to motor M1 can be cut off in the event of a failure of the phase-cutting switch K1, ensuring the safety of the ice crusher.

Specifically, the main motor control switch K2 can be a relay. The main control unit 132 is used to control the on-off state of the relay. The circuit principle of the main control unit 132 can refer to FIG. 4 and will not be elaborated here.

Referring to FIG. 4, the main control module 14 can first use the Relay signal to close the main motor control switch K2 and then use the Triac signal to control the phase-cutting switch K1 to control the operating mode of motor M1. The redundant setup of the main motor control switch K2 and the phase-cutting switch K1 provides additional safety for the ice crusher.

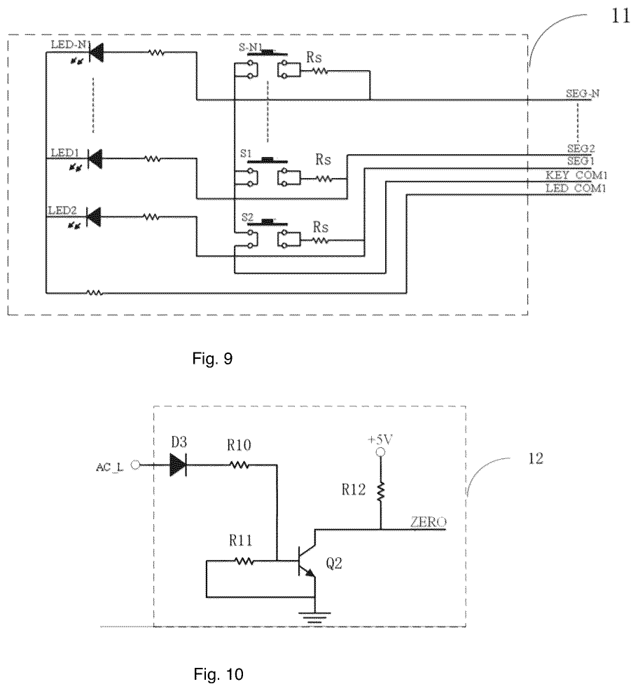

In a possible embodiment, referring to FIG. 9, the gear selection module 11 may include: a button communication terminal, an LED communication terminal, and at least two signal terminals. The button communication terminal, LED communication terminal, and at least two signal terminals are all connected to the main control module 14.

The gear selection module 11 may include: at least two gear switches (S1, S2 . . . . S-N1), at least two LED lights (LED1, LED2 . . . . LED-N1), and at least two current-limiting resistors Rs. Each gear switch corresponds to an LED light, a current-limiting resistor Rs, and a signal terminal one-to-one.

For each gear switch, the first end of the gear switch is connected to the first ends of the other gear switches and the LED communication terminal. The second end of the gear switch is connected to the first end of the corresponding current-limiting resistor Rs. The second end of the corresponding current-limiting resistor Rs is connected to the corresponding signal terminal and the anode of the corresponding LED light. The cathode of the corresponding LED light is connected to the LED communication terminal.

Exemplarily, the gear switch can be a button. When a button is pressed, the main control module 14 detects the corresponding button signal, lights up the corresponding LED light, and controls motor M1 to operate in the corresponding mode.

Specifically, the button communication terminal can be set to high level, and the LED communication terminal can be set to low level. When the corresponding button is pressed, the corresponding signal terminal outputs a high level, which is captured by the main control module 14, and the high level drives the corresponding LED light to illuminate.

To achieve more indication effects using LED lights, other gear switches' corresponding LED lights or combinations of two or more LED lights can be used to indicate the current operating mode of motor M1. Specifically, the signal terminals can be time-multiplexed. When a button is pressed, the signal terminals serve as outputs for the main control module 14 to collect button signals, and the LED lights do not illuminate at this time. Once the main control module 14 finishes signal collection, it sends LED control signals to the gear selection module 11 through the signal terminals to control the corresponding LED lights to illuminate, ensuring that the main control module 14 receives the button signals clearly before lighting up the corresponding LED lights. This guarantees the absolute control of the main control module 14 over the circuit.

In a possible embodiment, referring to FIG. 10, the input end of the zero-crossing detection module 12 is used to connect to the neutral line of the AC power source. The zero-crossing detection module 12 may include: a second switch transistor Q2, a third diode D3, a tenth resistor R10, an eleventh resistor R11, and a twelfth resistor R12.

The first end of the second switch transistor Q2 is connected to the first end of the twelfth resistor R12 and the output end of the zero-crossing detection module 12, respectively. The second end of the second switch transistor Q2 is grounded. The control end of the second switch transistor Q2 is connected to the first end of the tenth resistor R10 and the first end of the eleventh resistor R11, respectively.

The second end of the tenth resistor R10 is connected to the cathode of the third diode D3, and the anode of the third diode D3 is connected to the input end of the zero-crossing detection module 12.

The second end of the eleventh resistor R11 is grounded.

In this embodiment, zero-crossing detection is achieved through the second switch transistor Q2. When the AC power source is in the positive half-cycle, the second switch transistor Q2 conducts, and the zero-crossing detection module 12 outputs a low level. When the AC power source is in the negative half-cycle, the second switch transistor Q2 is off, and the zero-crossing detection module 12 outputs a high level, thereby detecting the zero-crossing point of the AC power source. This detection circuit has a simple structure and low cost, suitable for practical applications (the voltage of the AC power source is relatively high, and the conduction voltage of the second switch transistor Q2 is relatively low. It can be roughly considered that the second switch transistor Q2 switches states at the AC zero point).

Specifically, the second switch transistor Q2 can be an NPN-type transistor.

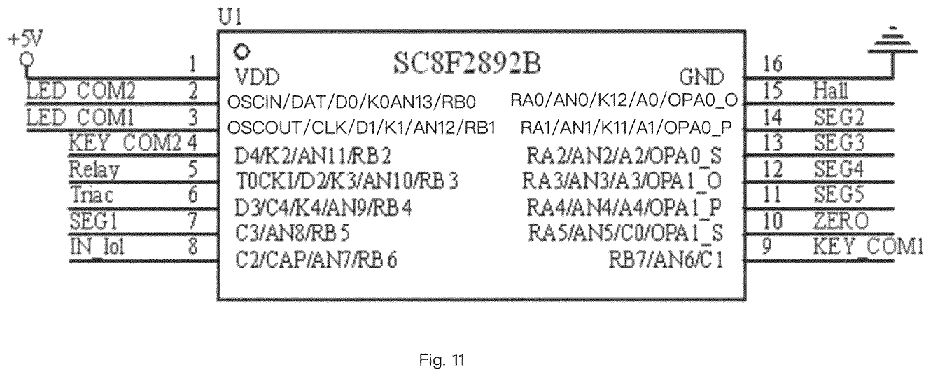

In a possible embodiment, referring to FIG. 11, the main control module 14 can be a microcontroller. The pin usage can refer to FIG. 11.

However, it is not limited to this; the main control module 14 can also be an FPGA or DSP, etc.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A motorized crushing apparatus, comprising:
a zero voltage detector coupled to an AC power source, wherein when a varying voltage of the AC power source is below zero, the zero voltage detector generates a first signal, wherein when the varying voltage of the AC power source is above zero, the zero voltage detector generates a non-zero signal;
a manual switch for a user to select a crushing pattern from multiple candidate crushing patterns;
a motor driver coupled to the AC power source;
a motor coupled to the motor driver to carrying a crushing device to crush an object in a container; and
a controller coupled to the zero voltage detector, the manual switch and the motor driver, wherein the controller generates a control signal corresponding to the selected crushing pattern to alternatively turn on and turn off the motor driver under a schedule pattern, wherein different candidate crushing patterns correspond to different control signals of different schedule patterns for crushing the object into different sizes and shapes.

2. The motorized crushing apparatus of claim 1, further comprising a TRIAC device that enables a phase range of the AC power source to output current to the motor driver and disables other phase of the AC power source not to output current to the motor driver.

3. The motorized crushing apparatus of claim 2, wherein the controller uses the TRIAC device to control total energy level supplied to the motor driver according to the selected crushing pattern.

4. The motorized crushing apparatus of claim 3, wherein the motor driver comprises a phase control unit, wherein the phase control unit is coupled to the TRIAC signal to disable a certain phase range of the AC power source not to output to the motor.

5. The motorized crushing apparatus of claim 1, wherein a schedule pattern corresponds to a series of duty ratios of power supplied to the motor over time, wherein a higher duty ratio corresponds to higher crushing force to the object in the container.

6. The motorized crushing apparatus of claim 5, wherein a series of gap time periods are inserted into the series of duty ratios.

7. The motorized crushing apparatus of claim 1, further comprising a blocking detector coupled to the AC power source to detect when the motor is blocked during operation.

8. The motorized crushing apparatus of claim 7, wherein the blocking detector is coupled to the controller, wherein when the controller determines a blocking occurs, the controller activates a de-blocking control signal corresponding to a schedule pattern trying to de-blocking the object in the container.

9. The motorized crushing apparatus of claim 7, wherein the blocking detector detects a current variation during the operation of the motor, wherein the current variation is provided to the controller to fine-tune the control signal even under the same selected crushing pattern.

10. The motorized crushing apparatus of claim 1, further comprising a manual setting switch, wherein the user operates the manual setting switch to operate the motor to crush the object, wherein when the controller records the schedule pattern corresponding to the operation of the user with the manual setting switch.

11. The motorized crushing apparatus of claim 10, wherein in future operation, the recorded schedule pattern is provided as an option among the multiple candidate crushing patterns.

12. The motorized crushing apparatus of claim 1, wherein the object comprises ice blocks.

13. The motorized crushing apparatus of claim 12, wherein the container has water container area for temporarily storing melted ice water to decrease resistance for the motor caused by the melted ice water.

14. The motorized crushing apparatus of claim 1, further comprising a camera to detect the size of the crushed iced blocks, wherein the controller is coupled to the camera to determine an adjusted control signal supplied to the motor driver.

15. The motorized crushing apparatus of claim 1, wherein the controller is coupled to an external device to receive a command, wherein the controller translate the command to generate a corresponding control signal.

16. The motorized crushing apparatus of claim 15, wherein the external device is a mobile phone installed with an APP, wherein the APP generates the command based on a recipe, wherein the command is related to ice block size and shape, wherein the controller translates the command to determine how to generate the control signal to achieve the requested ice block size and shape.

17. The motorized crushing apparatus of claim 1, further comprising a ice tray for generating a standard size of ice blocks designed for the controller to generate the control signal.

18. The motorized crushing apparatus of claim 17, further comprising a mode switch, wherein when the user uses the ice tray to generate the standard size of ice blocks, the user turns on the switch to inform the control to perform corresponding processing.

19. The motorized crushing apparatus of claim 1, further comprising a microphone to collect a sound during operation of the motor, wherein the microphone is coupled to the controller for the controller to determine operation of the crushing based on the sound.

20. The motorized crushing apparatus of claim 19, wherein the controller provides an operation status based on the sound via a display.
